(19) United States
(12) Patent Application Publication
(10) Pub. No.: US 2002/0133687 A1
(43) Pub. Date: Sep. 19, 2002

(54) Facilitating automatic incrementing and/or decrementing of data pointers in a microcontroller

(76) Inventors: Wendell L. Little, (US); Edward Tang Kwai Ma, Plano, TX (US); Frank V. Taylor III, Highland Village, TX (US); Ann Little, Corinth, TX (US)

Correspondence Address: JENKENS & GILCHRIST, 3200 Fountain Place, 1445 Ross Avenue, Dallas, TX, 75202-2799, US

(21) Appl. No.: 09/924,242

(22) Filed: Aug. 7, 2001

Related U.S. Application Data
(63) Continuation-in-part of application No. 09/187,503, filed on Nov. 6, 1998, now abandoned.
(60) Provisional application No. 60/223,176, filed on Aug. 7, 2000.
(60) Provisional application No. 60/223,668, filed on Aug. 7, 2000.

(51) Int. Cl. G06F 15/00; G06F 15/76

(52) U.S. Cl. 712/10

(57) ABSTRACT

An 8051-based style microcontroller system which is capable of using multiple data pointers while remaining compatible with 8-bit 8051 instruction-set compatible microcontrollers. A hardware feature for selecting one of two active data pointers is incorporated into the design. The design includes circuitry for incrementing/decrementing the active data pointer. Furthermore, there is included circuitry for enabling automatic incrementing/decrementing of the active data pointer.

### CROSS-REFERENCES TO RELATED APPLICATIONS

This Nonprovisional Application for Patent claims the benefit of priority from, and hereby incorporates by reference the entire disclosure of, co-pending U.S. Provisional Application for Patent Serial No. 60/223,176, filed on Aug. 7, 2000, and co-pending U.S. Provisional Application for Patent Serial No. 60/223,668, also filed on Aug. 7, 2000.

### BACKGROUND OF THE INVENTION

1. Technical Field of the Invention

The present invention relates to integrated circuit devices and, more particularly by way of example but not limitation, to microcontrollers.

2. Description of Related Art

The 8051 microcontroller core is a microcontroller core that is commonly used in “embedded control” applications. The term “8051” hereinafter includes any microcontroller that executes at least a substantial portion of the well-known 8051 instruction set. Embedded microcontrollers are frequently found in appliances (microwave ovens, refrigerators, televisions and VCRs, stereos), computers and computer equipment (laser printers, modems, disk drives), automobiles (engine control, diagnostics, climate control), environmental control (greenhouse, factory, home), instrumentation, aerospace, and thousands of other uses. Often more than one microcontroller can be found in a given item.

Microcontrollers are typically used in applications where processing power is not the highest concern. This is usually the case when the same task needs to be accomplished numerous times. For example, controlling a microwave oven is easily accomplished with the smallest of microcontrollers.

Another special application that microcontrollers are well suited for is data logging. A microcontroller can be placed in the middle of a corn field or up in a balloon to control electronics which monitor and record environmental parameters (temperature, humidity, rain, etc). This particular application requires much data movement within the memory of the microcontroller system.

An 8-bit microcontroller is used extensively in products today because of its small size, low power consumption, and flexibility. Because the market for 8-bit microcontrollers continues to grow, silicon manufacturers are pushing the development of faster, more efficient 8-bit microcontrollers.

The 8051 is a heavily used microcontroller at the present time. It is a very powerful and easy to program integrated circuit. Numerous software and hardware products are available for use with the 8051 line. A wide range of support tools and third-party products are also available to support 8051 microcontrollers, including emulators, compilers, prototyping/programming adapters, and development systems. In addition, many different variants of this chip are available to satisfy the requirements posed by various applications.

High-Speed 8051 Microcontrollers are a family of 8051-compatible microcontrollers providing increased performance compared to the traditional 8051 family. High-Speed 8051 Micros are 100% instruction set and object code compatible with the old Intel 8051 core.

To make faster 8051 microcontrollers, designers have implemented more efficient code, faster clocks, and circuits to handle the faster speeds. One problem with the past 8051 is that the instruction set only allows the programmer to increment the data pointer. There are no available instructions for a decrement function. Hence, in order to decrement the data pointer, the designer must use software to literally subtract one from the data pointer contents. Not only does this instruction take up additional space in the program memory; it also takes additional time when the program is executed. There is a need for an 8051 compatible microcontroller that supports a decrement function for the data pointer. A decrement instruction cannot be added to the existing 8051 instruction set because 255 of the 256 possible instructions are used and the remaining instruction is reserved.

Furthermore, another drawback of the prior 8051 instruction set is that it only allows for the use of one data pointer to address a particular memory location. Accomplishing block data moves with only a single pointer is very inefficient. Using current products, the programmer must accomplish a block data move between two blocks in memory by loading the address of the first block into the data pointer, retrieving the data at that address, and then temporarily storing the data. Then the address of the second block is loaded into the data pointer and the second block is moved to the location of the first block. The address of the temporary location of the first block is then loaded into the data pointer and the first block is moved from the temporary location to the address where the second block was originally located. If it is necessary to increment or decrement the data pointer from the original address after the move is accomplished; the original address must be loaded back into the data pointer. This not only requires additional memory in which to temporarily store the block, but it also requires additional time and program cycles in swapping the data in and out of the data pointers. The same problem is encountered when using a memory mapped peripheral for both source and destination address. Thus, there is a need for an 8051 compatible microcontroller that eliminates the time-consuming swapping of addresses in and out of a single data pointer.

Using the prior 8051 instruction set to accomplish block data moves (i.e., a set of instructions for moving blocks of data) disadvantageously required an increment or a decrement instruction after each move of memory location. Specifically, moving a block of data from a source memory location to a destination memory location requires one increment/decrement instruction for the data move from the source memory location to an accumulator and another increment/decrement instruction for the data move from the accumulator to the destination memory location. Thus, there is a need for an 8051 compatible microcontroller that utilizes fewer instructions to accomplish a block data move. Although 16-bit microcontrollers already contain dual data pointers with a decrement function within the instruction set, it is often very expensive to upgrade a system to a 16-bit microcontroller because all of the attached circuitry must also be redesigned and the software must be rewritten. Furthermore, 16-bit microcontrollers are generally more expensive initially and consume more power than the 8-bit microcontroller. Technological improvements in applications containing 8-bit 8051 microcontrollers have created a demand for faster 8-bit 8051 microcontrollers that may simply be “dropped in” to the existing circuitry without the need for changing the hardware as would be required to convert to a 16-bit microcontroller.

### SUMMARY OF THE INVENTION

Briefly described, and in accordance with embodiment(s) of the parent and/or present invention, an 8-bit 8051-based microcontroller system is provided with dual data pointers incorporated into the Special Function Registers (SFRs). The additional pointers are placed in SFRs, which are not used by the prior 8051 SFR map. Also added to the SFRs is a control register called the Data Pointer Select Register (DPS). The DPS Register contains a bit called the Data Pointer Select Bit (SEL) that determines the active/selected data pointer. Software may be used to change the bit during program execution. Software may also be used to change the Toggle Select Bit Enable bit, also in the DPS Register. When this bit is enabled, any instruction involving the data pointer automatically toggles the SEL bit, thus changing the active data pointer. An additional hardware feature is provided in the embodiment for decrementing the active data pointer. Two more bits in the DPS Register are used for this purpose. Depending on the value of the two bits, the active data pointer will be either incremented or decremented.

In an exemplary embodiment of the present invention, the incrementing/decrementing of the active data pointer is performed when an INC DPTR instruction is executed. In another exemplary embodiment of the present invention, an Automatic Increment/Decrement enable bit (AID) is included in the DPS Register to enable the automatic incrementing or decrementing of the active data pointer upon execution of a data pointer related instruction, such as a data move instruction. This feature advantageously saves time by avoiding the execution of a separate increment/decrement instruction because instead the incrementing/decrementing of the active data pointer is performed after the execution of a data pointer related instruction. As a result, additional increment/decrement instructions and clock cycles are not needed, thereby saving program execution time and program memory space. Although the microcontroller system in the exemplary embodiments is significantly faster than the prior 8051, it is fully drop-in compatible with 8-bit systems using the prior 8051 instruction set.

### BRIEF DESCRIPTION OF THE DRAWINGS

A more complete understanding of the method and apparatus of the present invention may be had by reference to the following detailed description when taken in conjunction with the accompanying drawings wherein:

FIG. 1A is a functional block diagram of a first preferred exemplary embodiment of the invention;

FIG. 1B is functional block diagram of the Core of the microcontroller of FIG. 1A;

FIG. 2A is a functional block diagram of a second preferred exemplary embodiment of the invention; and

FIG. 2B is a functional block diagram of the Core of the microcontroller of FIG. 2A;

FIG. 3 illustrates an exemplary integrated circuit/block diagram that could be used for implementing the dual data pointer functions of the exemplary microcontrollers;

FIG. 4 illustrates another exemplary integrated circuit/block diagram implementing the dual data pointer functions and the automatic increment/decrement function of the exemplary microcontrollers;

FIG. 5 illustrates an exemplary flow diagram of the operation of the exemplary integrated circuit/block of FIG. 4 utilizing the automatic increment/decrement function; and

FIG. 6 illustrates an exemplary method in flowchart form for conditionally modifying a data pointer in accordance with the present invention.

### DETAILED DESCRIPTION OF EXEMPLARY EMBODIMENTS

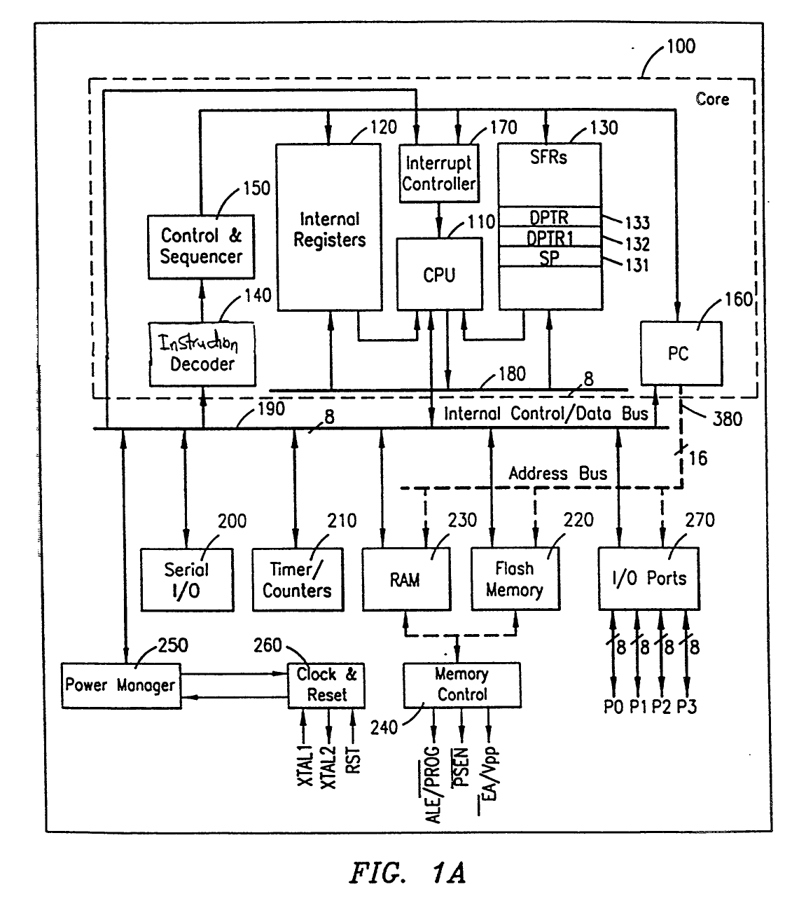

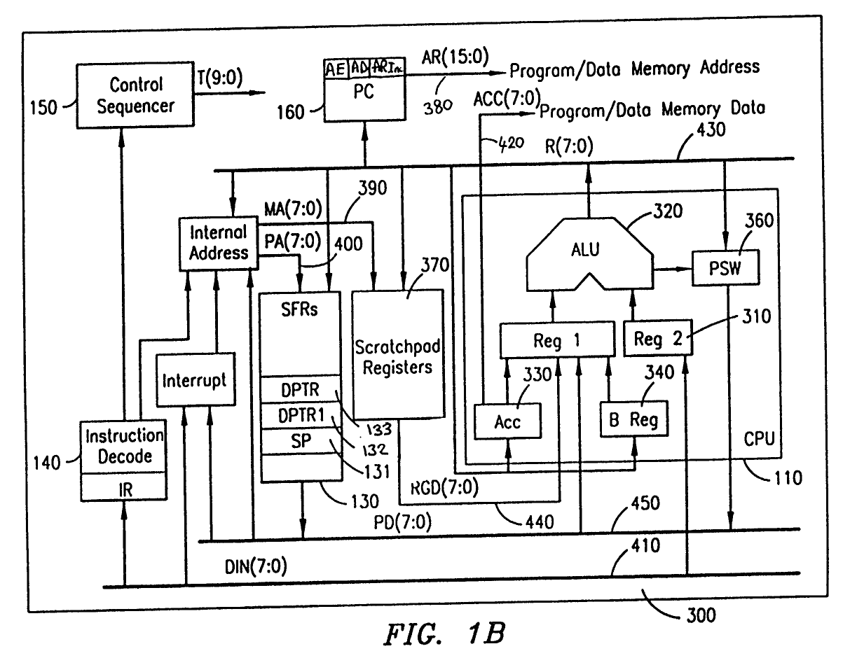

The exemplary embodiments of the present invention and its advantages are best understood by referring to FIGS. 1-6 of the drawings, wherein like numerals are used for similar or corresponding parts of the various drawings.

The preferred exemplary embodiments of the microcontroller disclosed below provide one of the fastest 8051 microcontrollers available. The redesigned processor core in the preferred exemplary embodiments provides user-programmable features that modify the INC DPTR instruction to allow the data pointers to be decremented as well as incremented. The user may also program the core to automatically toggle the selection of data pointers after specific instructions in which the data pointer is used. The user may also program the core to automatically increment/decrement the data pointer upon execution of a data move instruction. The preferred exemplary embodiments offer a maximum crystal speed of 40 MHz, but it is understood that faster crystal speeds could be utilized in other embodiments. Eliminating steps in the program for the microcontrollers by providing dual data pointers and a decrement function in the hardware further increases the speed of the microcontrollers. The speed is increased by over 60% when compared with a single data pointer device. Moreover, the automatic increment/decrement function further increases the speed by saving clock cycles consumed in normal increment/decrement instructions.

One of the preferred exemplary embodiments incorporates an 8051-compatible high-speed microcontroller core which has been designed to reduce the instruction execution time from the original 8051's 12 clocks per machine cycle to one clock per machine cycle, with a maximum clock speed of 40 MHz. The preferred embodiments are functionally and pin compatible with the 80C52 and are compatible with the 8051 instruction set. Certain embodiment(s) include standard resources such as three 16-bit timers/counters, 256 bytes of scratchpad RAM, 1K bytes of on-chip data SRAM, a programmable Watchdog Timer, and two full-duplex hardware serial ports.

Referring now to FIG. 1A, there is illustrated a functional block diagram of a first preferred exemplary embodiment of the invention. The microprocessor core 100 contains a CPU 110, Internal Registers 120, Special Function Registers 130, an Instruction Decoder 140, a Control and Sequencer 150, a Program Counter 160, an Interrupt Controller 170, and an 8-bit data bus 180. The elements are placed into communication with each other as shown in FIG. 1A. The Internal Registers 120 include a scratchpad register area, which includes four 8-byte banks of working registers. Sixteen bytes of the scratchpad area, which may also be used as a program stack, are bit addressable. The Special Function Registers 130 are preferably located in memory locations 80h to FFh. These registers control the on-chip peripherals and memory configurations and are preferably accessed via direct addressing but could be addressed via indirect addressing. The two data pointers DPTR 133 and DPTR1 132 support fast data movement in data memory. The Instruction Decoder 140 contains an Instruction Register and a decode logic that generates most of the control signals for each instruction. The Control and Sequencer 150 provides logic control and operation sequencing for the core. The Program Counter (PC) 160 contains the Address Register (AR) as well as the increment logic to address the program and data memory. The Interrupt Controller 170 contains the control logic that detects and services all incoming interrupts to the microcontroller.

An 8-bit Internal Control/Data bus 190 is used to connect the microcontroller core 100 to the various other parts of the microcontroller. The Serial I/O 200 supports serial communication and provides two fully independent UARTs, not shown, for simultaneous communication over two channels. The Timer/Counters 210 block includes three timers as well as the necessary control logic for the timers. The Flash Memory 220 contains 16K bytes of on-chip Flash memory for program storage. The RAM 230 contains 1K bytes of on-chip RAM for data memory. The Memory Control 240 provides access controls for internal and external memory and supports Flash memory reprogramming. The Power Manager 250 incorporates a band-gap reference and analog circuitry to monitor the power supply conditions and also a Watchdog Timer. The Clock and Reset 260 contains the reset control logic and the clock control register, and generates the system clocks for core logic and the peripheral clocks for the external interface. The I/O Ports 270 are composed of parallel bi-directional pins for external memory access and external interrupts and can either be written to or read from.

Referring now to FIG. 1B, there is illustrated a functional block diagram of the Core 100 of FIG. 1A. The CPU 110 is code compatible with a standard 8051 microprocessor's code instructions. The Core 100 is capable of executing its fastest instruction in one clock cycle at 40 MHz. The instruction is fetched and sent over the DIN(7:0) 410 internal data bus to the register 310 of the ALU execution unit 320. The ALU 320 performs math and logical operations, and makes comparisons and general decisions. The Accumulator 330 (ACC) is the primary register used in the CPU and is the source or destination of most operations. The B Register 340 is used as the second 8-bit argument in multiply and divide operations and can also be used as a general purpose register. The Program Status Word (PSW) 360 contains several flags including the Carry Flag, the Auxiliary Carry Flag, the General Purpose Flag, the Register Bank Selection bits, the Overflow Flag, and the Parity Flag.

Working in cooperation with the CPU 110 are various other functional devices. The Scratchpad Registers 370 is a RAM containing 256 registers available for general purpose data storage. The program stack is located anywhere in the 256 bytes of RAM in the Scratchpad Registers 370 depending on the value of the Stack Pointer 131. The Stack Pointer (SP) 131 designates the RAM location that is at the top of the stack. The Program Counter (PC) 160 is a 16-bit value that designates the next program address to be fetched.

There are preferably three internal address buses and five internal data buses in the Core 100 logic for connecting the various functional devices. The AR(15:0) address bus 380 provides addresses for opcode/operand fetching and data memory read/write operations. The MA(7:0) address bus 390 is a split read/write address bus for the dual-port internal data RAM and supports simultaneous read and write operations. The PA(7:0) address bus 400 provides the read/write addresses for SFRs 130. The DIN(7:0) 410 is the main data bus in the core and is used for instruction fetches from the program memory and data read from the data memory. The ACC(7:0) 420 is the Accumulator data bus from the Core 100 and is primarily used for writing data to the data memory and program memory. The R(7:0) 430 is the data input bus for all internal registers and is used for output of all ALU 320 operations to the Scratchpad Registers 370 and the SFRs 130. The RGD(7:0) 440 is the data output bus for the Scratchpad Registers 370. The PD(7:0) 450 is the data output bus for the SFRs 130.

All peripherals and operations that are not explicit instructions are controlled via Special Function Registers (SFRs) 130. The common features that are basic to the architecture of the microcontroller are mapped to the SFRs 130. These include the CPU registers (ACC 330, B Reg 340, and PSW 360), the dual data pointers (DPTR 133 and DPTR1 132), the stack pointer (SP) 131, the I/O Ports 270, the Timer/Counters 210, and the serial ports 200. The data pointers (DPTR 133 and DPTR1 132) are used to assign a memory address for the MOVX instructions in the 8051 instruction set. This address can point to either a RAM location (on or off chip) or to a memory-mapped peripheral. Two pointers are useful when moving data from one memory area to another, or when using a memory mapped peripheral for both source and destination addresses. The user can select the active pointer using a dedicated SFR bit or can activate an automatic toggling feature for altering the pointer selection when certain instructions using the data pointer are executed. The user can also select the automatic increment/decrement function to be active using another dedicated SFR bit, thus enabling automatic incrementing/decrementing of the active pointer upon execution of a data move instruction. The standard SFR locations from the prior 8051 are duplicated in this exemplary embodiment. Several SFRs have been added to support the unique features of the present invention. Most of these features are controlled by bits in SFRs located in unused locations in the 8051 SFR map. This allows for increased functionality while maintaining 8051 instruction set compatibility.

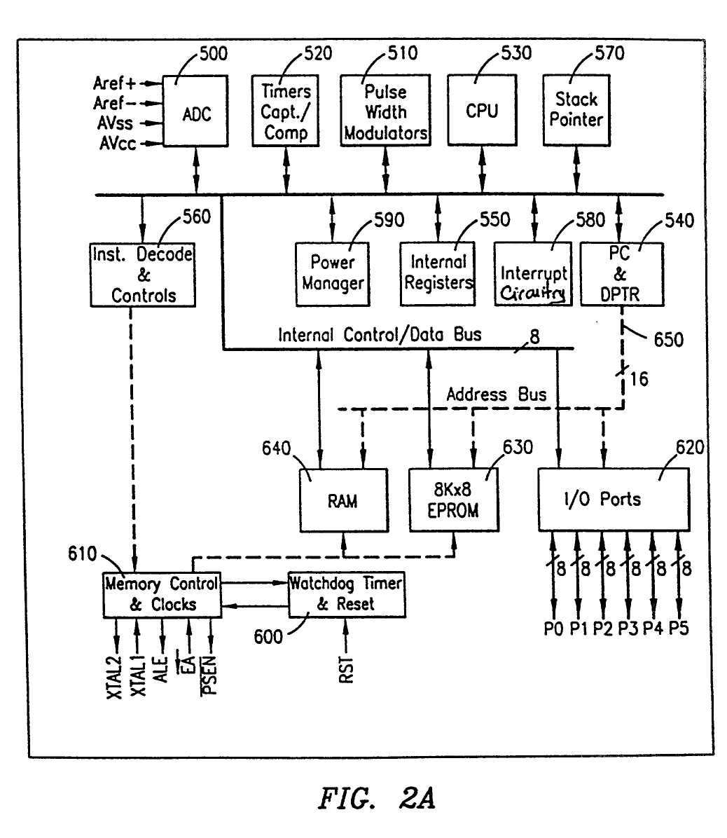

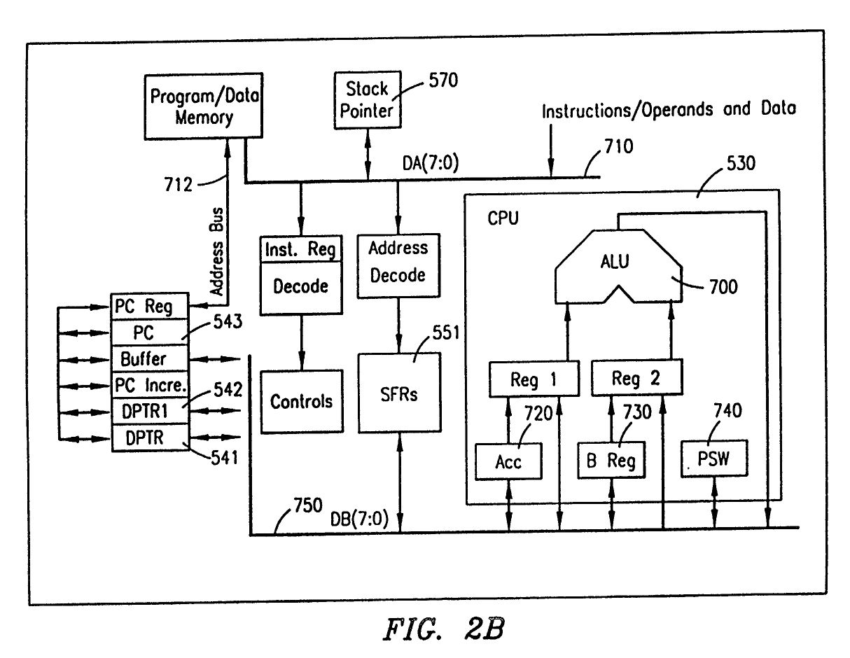

Referring now to FIG. 2A, there is illustrated a functional block diagram of a second preferred exemplary embodiment of the invention. This embodiment of the invention incorporates an 8051-compatible high-speed microcontroller core, which has been redesigned to reduce the original 8051's 12 clocks per instruction cycle to four clocks per instruction cycle. The embodiment of FIG. 2A is very similar to the embodiment shown in FIG. 1A. However, there are some additional features added to the microcontroller. In addition to providing standard 8051 functions with higher throughput, this exemplary embodiment incorporates an 8-channel, 10-bit A/D Converter 500 and four 8-bit Pulse Width Modulators 510 that generate programmable lengths and intervals. These modulators can be combined into two 16-bit modulators to provide longer repetition intervals and better pulse width resolutions. The Timers 520 support capture and compare functions in addition to their standard use as a standard 16-bit timer/counter. Also provided are user-programmable features that modify the INC DPTR instruction to decrement the data pointers and/or automatically toggle the selection of data pointers after specific instructions. The CPU 530 contains the ALU for arithmetic calculations and logical functions, as well as the accumulator, program status word and the B register. The PC & DPTR 540 contains the program counter, the two data pointers DPTR and DPTR1, and the DPS register used to support user active data pointer options. The Internal Registers 550 is an on-chip RAM that is divided into Scratchpad Register and Special Function Register (SFR) areas. Register addresses 00-7Fh are scratchpad registers that include four 8-byte banks of working registers R0-R7. The SFRs are preferably located in locations 80h to FFh and are used to control on-chip peripherals and memory configuration. The Instruction Decode & Controls 560 contains the instruction register, the NOR-plane and the timing plane of the PLA, which generates most of the control signals for each instruction. The Stack Pointer 570 contains the stack pointer register that may be accessed during interrupts, ACALL, LCALL, PUSH, and POP instructions and is used to address memory locations in the scratchpad RAM. An Interrupt Circuitry 580 contains control logic that detects and services all incoming interrupts to the microcontroller.

The Timers 520 include three timers as well as the necessary control logic for the timers. A Power Manager 590 incorporates a band-gap reference and analog circuitry to monitor power supply conditions. A Watchdog Timer and Reset 600 contains reset control logic, a Watchdog register and a power control register which works with the Power Manager 590. The Memory Control & Clocks 610 generates four phase clocks, five machine cycle clocks, and four peripheral clocks. I/O Ports 620 are composed of bi-directional pins, with each pin having an associated latch accessed from the SFR. There are three distinct memory areas in this exemplary embodiment of the invention: SFRs, Program memory, and Data memory. All of the registers are located on-chip but the program and data memory space can be on-chip, off-chip, or both. There are 8K bytes of on-chip memory implemented in an EPROM 630 and 1K bytes of on-chip data memory space implemented in RAM 640. 256 bytes of on-chip scratchpad RAM serves as a Special Function Register (SFR) area and a program stack. This is preferably separate from data memory.

Referring now to FIG. 2B, there is illustrated a functional block diagram of the CPU core 530 of the microcontroller of FIG. 2A. An instruction is fetched and sent over the 8-bit internal data bus DA(7:0) 710 to the register of the execution unit ALU 700. The ALU 700 performs math functions, logical operations and makes comparisons and general decisions. The ALU primarily uses the Accumulator (ACC) 720 and the B Register 730 as the source or destination for operations. The Program Status Word 740 contains several flags, including Carry Flag, Auxiliary Carry Flag, General Purpose Flag, Register Bank Select bits, Overflow Flag, and Parity Flag.

The Data Pointers (DPTR 541 & DPTR1 542) are used to assign a memory address for the MOVX instruction. Although the prior 8051 microcontroller core only had one pointer, two pointers are useful when moving data from one memory area to another memory area, or when using a memory mapped peripheral for both source and destination addresses. The Stack Pointer 570 denotes the register location at the top of the stack, which is the last used value.

There are three main internal buses: one 16-bit Address Bus 712 and two 8-bit Data Buses (DA(7:0) 710 & DB(7:0) 750). The Address Bus 712 provides the address for opcode/operand fetching and all external instructions. The DA data bus 710 is used for addressing of SFRs, for fetched instructions and operands from external memory, and for providing addresses to the internal stack. The DB data bus 750 is used for data exchange between SFRs 551 and for output of all ALU 700 operations.

Special Function Registers (SFRs) 551 provide the user with selected functions that are not explicit instructions in the 8051 instruction set. However, all of the standard SFR locations from the prior 8051 are duplicated in the exemplary embodiment illustrated by FIG. 2B. Several registers have been added to support the unique features of this embodiment. Most of these features are controlled by bits in SFRs located in unused locations in the 8051 SFR map. This allows for increased functionality while maintaining complete instruction set compatibility.

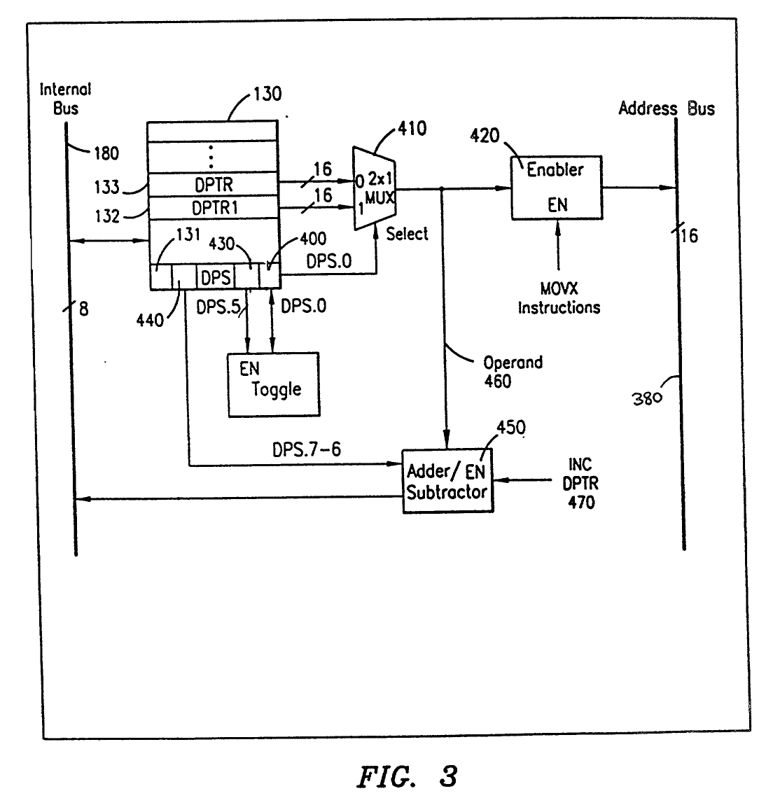

Referring now to FIG. 3, there is illustrated an exemplary integrated circuit/block diagram that could be used for implementing the dual data pointer functions of the exemplary microcontrollers in FIGS. 1A and 2A. In the SFRs 130 are located two data pointers, DPTR 133 and DPTR1 132. Also shown in the SFRs is a Data Pointer Select Register (DPS) 131 consisting of 8 bits. Bits 1-4 are reserved. Bit 0 (DPS.0) 400 is the Data Pointer Select Bit (SEL) and is used to select the active data pointer. This bit is connected to the select input on a 2×1 multiplexer (MUX) 410. The DPTR 133 is connected to the “0” input on the MUX 410 and the DPTR1 132 is connected to the “1” input on the MUX 410. Thus, when the SEL bit 400 is set to a logical “0” the DPTR 133 data pointer is connected to the output of the MUX 410. When the SEL bit 400 is set to a logical “1” the DPTR1 data pointer 132 is connected to the output of the MUX 410. The user may select the appropriate data pointer by setting the SEL bit 400 to the desired value. An Enabler 420 is connected between the MUX 410 and the Address Bus 380 such that the address stored in the active data pointer is only sent to the Address Bus 380 when a MOVX instruction activates the Enabler 420. Bit 5 of the DPS 131 is the Toggle Select Bit Enable (DPS.5) 430. When the DPS.5 bit 430 is set to a logic 1, the SEL bit 400 is automatically toggled after execution of the following data pointer related instructions: INC DPTR; MOV DPTR #data16; MOVC A, @A+DPTR; MOVX A, @DPTR; and MOVX @DPTR, A. Otherwise, if the DPS.5 bit is set to a logic 0, no instruction will alter the SEL bit 400 unless it is specifically supposed to do so (no instruction will automatically alter it). Bits 6-7 (DPS.6, DPS.7) 440 are the Increment/Decrement Bits ID0 and ID1, respectively. These bits define how the INC DPTR instruction functions in relation to the active data pointer as determined by the SEL bit. Table 1 indicates the effects of ID0 and ID1 on the INC DPTR instruction. Note that the data pointer which is affected depends on the value of the SEL bit 400. Depending on the values of the ID0 and ID1 bits, the Adder/Subtractor 450 will either add one to the data pointer or subtract one from it.

TABLE 1

| ID1 | ID0 | SEL = 0 | SEL = 1 |
|---|---|---|---|
| 0 | 0 | Inc. DPTR | Inc. DPTR1 |
| 0 | 1 | Dec. DPTR | Inc. DPTR1 |
| 1 | 0 | Inc. DPTR | Dec. DPTR1 |
| 1 | 1 | Dec. DPTR | Dec. DPTR1 |

The Operand Input 460 is connected to the output of the MUX 410. The only data pointer that is incremented/decremented is the one that is selected by the MUX at the time the Adder/Subtractor 450 is enabled by an INC DPTR instruction 470. Once enabled, the output of the Adder/Subtractor is written over the old value of the active data pointer via the Internal Bus 180.

As a result, a dual data pointer is implemented in hardware. Each of the dual data pointers can be incremented or decremented. By being able to increment or decrement each of the data pointers, block data moves are easily facilitated in an 8051 style microcontroller core. All the while the exemplary embodiments remain compatible with the standard 8051 instruction set.

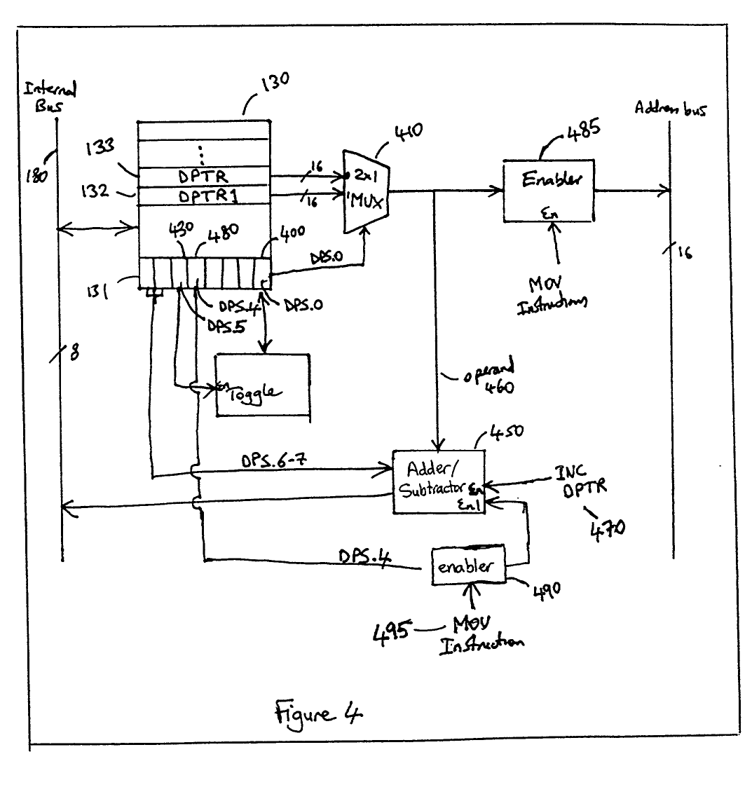

Referring now to FIG. 4, there is illustrated another exemplary integrated circuit/block diagram for implementing the dual data pointer functions and the automatic increment/decrement function of the exemplary microcontrollers in FIGS. 1A and 2A. The SFRs 130 contain two data pointers, DPTR 133 and DPTR1 132, which function in a similar fashion as described hereinabove with reference to FIG. 3. The Data Pointer Select (DPS) Register 131, as mentioned above, may have eight bits. However, in this exemplary embodiment, only bits 1-3 are reserved. Bit 0 (DPS.0) 400 of the DPS Register 131 is the Select (SEL) bit 400. As described above, when the SEL bit (DPS.0) 400 is set to a logic 0, the DPTR 133 is incremented/decremented and when the SEL bit 400 is set to a logic 1, the DPTR1 132 is incremented/decremented. The incrementing or decrementing function is dependent on the setting of the ID0 and ID1 bits (DPS.6 and DPS.7, respectively), as described hereinabove with reference to Table 1.

In accordance with the exemplary data pointer block diagram of FIG. 4, bit 4 (DPS.4) is an automatic increment/decrement (AID) enable bit 480 used to indicate whether an automatic increment/decrement of the active data pointer is to be performed after the execution of a data pointer related instruction. The data pointer related instruction may be, for example: MOVC A,@A+DPTR; MOVX A,@DPTR; and MOVX@DPTR,A.

When the AID enable bit 480 is set to a logic 1, the adder/subtractor 450 may be enabled which then increments/decrements only the data pointer selected and/or made active by the MUX 410. In addition, the adder/subtractor 450 is preferably enabled when a data pointer related instruction is executed while the AID enable bit 480 is set to a logic 1. The active data pointer is therefore automatically incremented/decremented by one after execution of a data pointer related instruction when the AID enable bit 480 is set to a logic 1. However, when the AID enable bit 480 is cleared to a logic 0, a data pointer related instruction will not affect the content of the active data pointer or otherwise automatically increment the active data pointer. Nonetheless, as mentioned above, an increment (INC) instruction 470 will enable the adder/subtractor 450 and increment/decrement the active data pointer irrespective of the value of the AID enable bit 480. A user may thus select the automatic increment/decrement function by setting the AID enable bit 480 to a logic 1 or select a manual increment/decrement function by using an increment (INC) instruction 470. Block data moves are relatively easily accomplished using the exemplary embodiment described in FIG. 4 by automatically incrementing/decrementing the data pointer. The automatic incrementing/decrementing of the data pointer allows the next move operation of a block data move to be performed on the next memory location pointed by the automatically incremented/decremented data pointer, thus saving additional incrementing/decrementing instructions which saves clock cycles (time).

Referring again to FIG. 4, a programmer/user may set the AID enable bit 480 by executing a write instruction for the AID enable bit 480 or for the DPS register 131. The value of the AID enable bit 480 is provided to an enabler 490 operable to enable the automatic increment/decrement function performed by the Adder/Subtractor 450. However, based on the value of the AID enable bit 480 alone, the enabler 490 does not enable the Adder/Subtractor 450. The enabler 490 only enables the Adder/Subtractor 450 to perform an automatic increment/decrement operation on the active data pointer when a relevant data move instruction 495 (e.g., MOVC A,@A+DPTR; MOVX A,@DPTR; MOVX @(DPTR,A; etc.) is executed. Thus, an enable signal is supplied, by the enabler 490, to an enable input (EN1) of the Adder/Subtractor 450 upon execution of the relevant data move instruction 495 while the AID enable bit 480 is set to a value of logic 1. The enable input (EN1) allows the Adder/Subtractor 450 to perform the above mentioned automatic incrementing/decrementing operation.

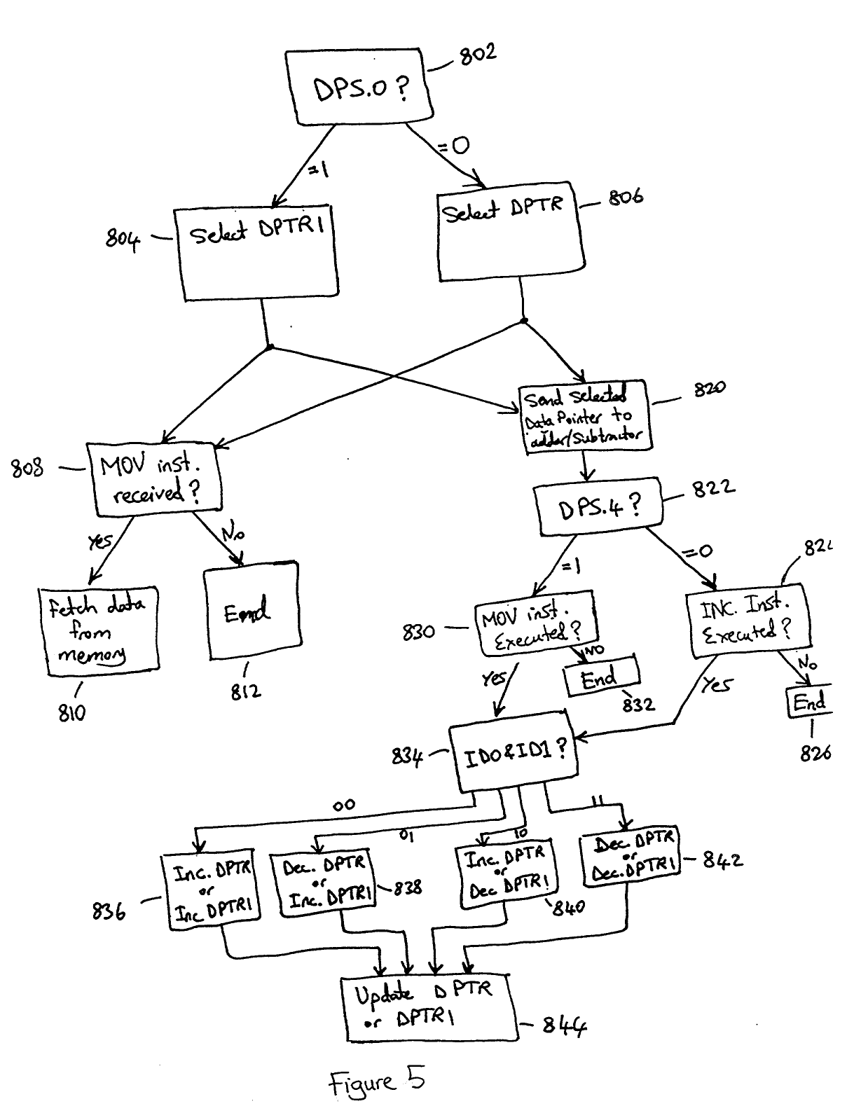

Referring now to FIG. 5, there is illustrated an exemplary flow diagram of the operation of the exemplary embodiment of the integrated circuit of FIG. 4 utilizing the automatic increment/decrement function. The SEL bit (DPS.0) is used to select one of the two data pointers (step 802). If SEL bit 400 is at logic 0 the MUX 410 selects DPTR 133 (step 806), and if SEL bit is at logic 1 the MUX 410 selects DPTR1 132 (step 804). When one of the data pointers is selected and/or made active, an enabler 485 awaits for a data pointer related instruction, such as a data move instruction MOVX (step 808). Upon execution of a data move instruction, the memory location address contained within the active data pointer is used to fetch the data from memory (step 810). Before, after, or preferably approximately concurrently with steps 808 and 810, the contents of the active data pointer is sent to the adder/subtractor (step 820) to perform the operation on the content of the active data pointer. Before any operation is performed on the contents of the active data pointer, the AID enable bit 480 is examined (step 822). If the AID enable bit 480 is a logic 1 and a data pointer related instruction, such as a data move instruction, has been executed (step 830), the adder/subtractor 450 is enabled. The adder/subtractor 450 may also be enabled using an increment instruction (step 824) even when the AID enable bit 480 is at a logic 0. However, if the AID enable bit 480 is set to a logic 1 but no data pointer related instruction has been executed, the operation ends and the adder/subtractor does not increment/decrement the active data pointer (step 832).

After the data pointer related instruction is executed while the AID enable bit 480 is set to a logic 1, the adder/subtractor 450 examines the ID0 and the ID1 bits to determine whether an increment or a decrement needs to be performed (step 834). If the ID0 is at logic 0 and the ID1 is at logic 0, the adder/subtractor 450 increments the active data pointer (step 836). If the ID0 is at logic 0 and the ID1 is at logic 1, the adder/subtractor 450 decrements the DPTR if the DPTR was the active data pointer determined at step 806 and increments the DPTR1 if the DPTR1 was the active data pointer determined at step 804 (step 838). If the ID0 is at logic 1 and the ID1 is at logic 0, the adder/subtractor 450 increments the DPTR if the DPTR was the active data pointer determined at step 806 or decrements the DPTR1 if the DPTR1 was the active data pointer determined at step 804 (step 840). Finally, if the ID0 is at logic 1 and the ID1 is at logic 1, the adder/subtractor 450 decrements the active data pointer (step 842). The result of the operation (any one of steps 836, 838, 840 and 842) is used to update the active data pointer (step 844) through the internal bus 180, while the other data pointer is unchanged. It should be understood that the flow diagram illustrated in FIG. 5 is for a single instruction and this process can be repeated in each instruction in a set of block data moves. It should also be understood that one or more of the steps of FIG. 5 may operate or be performed in parallel in actual circuit logic and that the implementing logic therefor may differ from the exemplary logic of FIG. 4.

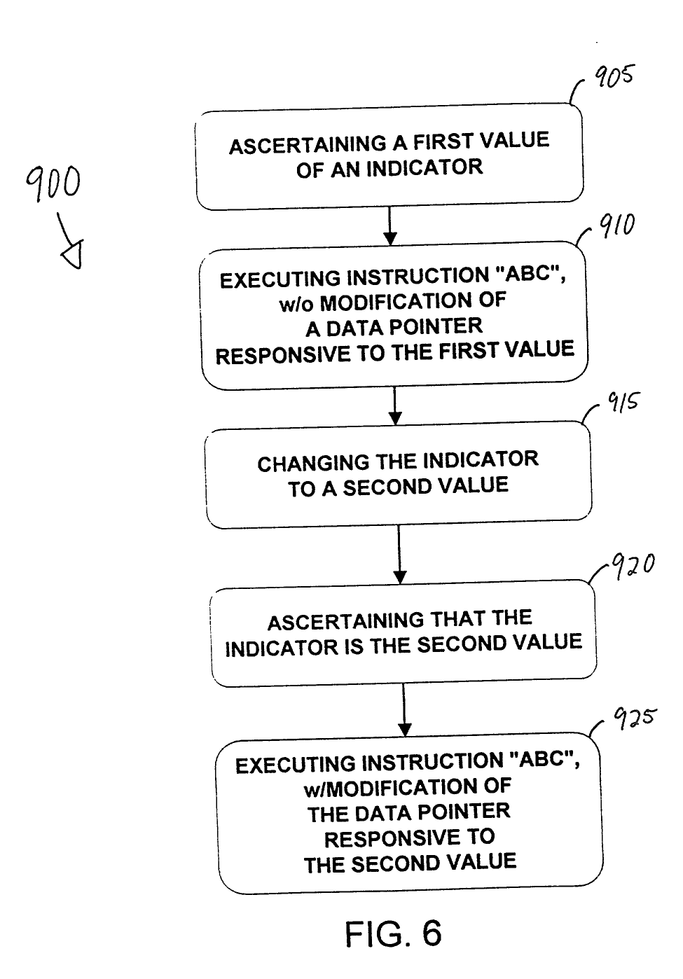

Referring now to FIG. 6, an exemplary method in flowchart form for conditionally modifying a data pointer in accordance with the present invention is illustrated generally at 900. In the flowchart 900, a first value (e.g., a “0”, a“1”, a series thereof, etc.) of an indicator (e.g., one or more bits in a register) is ascertained (step 905). An instruction “ABC” (e.g., a memory move instruction such as MOVC A,@A+DPTR; MOVX A,@DPTR; MOVX @DPTR,A; etc.) is executed without modifying a data pointer (e.g., a value pointing to a memory location) based on the indicator being the first value (step 910). The indicator may be changed to at least a second value (step 915). Thereafter, it may be ascertained that the indicator is the second value (step 920). Based on the indicator being the second value, the instruction “ABC” is executed and the data pointer is modified (e.g., incremented, decremented, etc.) (step 925). It should be noted that one or more steps of the flowchart 900 may be performed in parallel (e.g., at least substantially simultaneously). For example, a microcontroller may operate such that steps 920 and 925 occur substantially simultaneously as the circuit logic thereof executes code. Advantageously, the method of flowchart 900 enables a device including a microcontroller that is operating in accordance with certain embodiment(s) thereof to automatically increment/decrement one or more data pointers or not automatically increment/decrement the one or more data pointers when executing an identically identified 8051-compatible instruction depending on the value of an indicator therein.

Although preferred embodiment(s) of the method and apparatus of the present invention have been illustrated in the accompanying Drawings and described in the foregoing Detailed Description, it will be understood that the invention is not limited to the embodiment(s) specifically disclosed, but is capable of numerous rearrangements, modifications and substitutions without departing from the spirit of the invention as set forth and defined by the following claims.

What is claimed:

1. An apparatus, comprising:
a microcontroller, said microcontroller comprising:
two data pointers, each data pointer pointing to a data memory location; and
a microcontroller core being capable of automatically incrementing/decrementing a selected one of the two data pointers based upon a value of an automatic increment/decrement (AID) enable bit and upon execution of a data pointer related instruction.

2. The apparatus of claim 1, wherein the data pointer related instruction is a data move instruction.

3. The apparatus of claim 1, wherein the microcontroller core is further capable of incrementing/decrementing the selected one of the two data pointers upon the execution of an increment instruction.

4. The apparatus of claim 1, wherein the microcontroller core automatically increments/decrements the selected one of the two data pointers when the AID enable bit is at a first logic value and does not automatically increment/decrement the selected one of the two data pointers when the AID enable bit is at a second logic value.

5. The apparatus of claim 1, wherein said microcontroller core further comprises an Arithmetic Logic Unit (ALU) wherein the automatic incrementing/decrementing instruction is performed.

6. The apparatus of claim 1, wherein said apparatus comprises at least one of: a microwave oven, a refrigerator, a television, a radio, a VCR, a stereos, a laser printer, a modem, a disk drive, an automotive engine controller, an automotive engine diagnosticator, and a climate controller.

7. In a microcontroller, a method for automatically incrementing/decrementing data pointers, said method comprising the steps of:
selecting a data pointer from two data pointers;
determining a value of a bit in a data pointer select register; and
automatically altering the value in the data pointer, based upon the value of the bit in the data pointer select register.

8. The method of claim 7, further comprising the step of:
determining whether an instruction is a data pointer related instruction, wherein the step of automatically altering the value in the data pointer is further based upon the determination that the instruction is a data pointer related instruction.

9. The method of claim 7, wherein the step of automatically altering the value in the data pointer comprises automatically incrementing the data pointer.

10. The method of claim 7, wherein the step of automatically altering the value in the data pointer comprises automatically decrementing the data pointer.

11. The method of claim 7, wherein the value in the data pointer is altered upon the value of the bit in the data pointer select register being at a first value and not altered upon the value of the bit in the data pointer select register being at a second value.

12. The method of claim 7, further comprising:
prior to the automatically altering step, executing a data pointer related instruction, wherein the step of automatically altering comprises the step of altering the value in the data pointer upon execution of the data pointer related instruction.

13. A microcontroller, comprising:
two data pointers;
a register, the register including at least a first bit and a second bit;
a selecting circuit for selecting one of the two data pointers based upon a value of the first bit of the register; and
a circuit for automatically altering the selected one of the two pointers based upon a value of the second bit of the register.

14. The microcontroller of claim 13, wherein the register is a data pointer select register within a special function register.

15. The microcontroller of claim 13, wherein the circuit comprises an adder/subtractor circuit for automatically incrementing/decrementing the selected one of the two data pointers based upon the value of the second bit of the register.

16. The microcontroller of claim 15, wherein the adder/subtractor circuit is configured to add one to or subtract one from the selected one of the two data pointers based upon at least a third bit of the register.

17. The microcontroller of claim 15, wherein said circuit further comprises an enabling circuit for enabling said adder/subtractor circuit following the execution of a data pointer related instruction by the microcontroller.

18. A method for operating a microcontroller in a processor-controlled apparatus, comprising the steps of:
first executing of a predetermined instruction, whereby the step of first executing does not cause a data pointer value to be modified based on a first value of a given indicator;
changing the given indicator to a second value;
second executing of the predetermined instruction, whereby the step of second executing does cause the data pointer value to be modified based on the second value of the given indicator.

19. The method of claim 18, wherein the given indicator comprises a bit in a register of the microcontroller and the data pointer value is modified in the step of second executing by at least one of incrementing and decrementing the data pointer value.

20. The method of claim 18, further comprising the steps of:
ascertaining that the given indicator comprises the first value; and
ascertaining that the given indicator comprises the second value.

21. The method of claim 18, wherein the predetermined instruction comprises a memory move instruction.

22. The method of claim 18, wherein the given indicator does not comprise the operand of the predetermined instruction.

23. An apparatus for automatically incrementing/decrementing a data pointer, comprising:
at least one data pointer;
at least one indicator; the at least one indicator capable of providing at least one of at least two values;
circuitry, the circuitry operably arranged with the at least one data pointer and the at least one indicator so as to enable the execution of a plurality of instructions; and
wherein the circuitry is configured such that execution of a specific instruction of the plurality of instructions results in the at least one data pointer being at least one of incremented and decremented when the at least one indicator comprises a first value of the at least two values and such that execution of the specific instruction of the plurality of instructions does not result in the at least one data pointer being either incremented or decremented when the at least one indicator comprises a second value of the at least two values.

24. The apparatus of claim 23, wherein the apparatus comprises a microcontroller.

25. The apparatus of claim 23, wherein the apparatus comprises an electronic device that includes at least one microcontroller.

26. The apparatus of claim 23, wherein the specific instruction comprises a memory move instruction.
